(19) United States
(12) Patent Application Publication
(10) Pub. No.: US 2010/0115508 A1
(43) Pub. Date: May 6, 2010

(54) PLUG-IN ARCHITECTURE FOR HYPERVISOR-BASED SYSTEM

(75) Inventors: Mark Charles Davis, Durham, NC (US); Charles Burnham Oxrieder, Wake Forest, NC (US); David Rivera, Durham, NC (US); Rod David Waltermann, Rougemont, NC (US)

Correspondence Address: ROGITZ & ASSOCIATES, 750 B STREET, SUITE 3120, SAN DIEGO, CA, 92101, US

(73) Assignee: LENOVO

(21) Appl. No.: 12/261,386

(22) Filed: Oct. 30, 2008

(51) Int. Cl. G06F 9/455

(52) U.S. Cl. 718/1

(57) ABSTRACT

In a hypervisor-based computing system, each guest operating system (GOS) is associated with multiple plug-in modules, with each module being configured to execute a respective function. The hypervisor also includes plug-in modules mirroring those of the GOS to provide for enhanced functionality on a module-by-module basis.

### I. FIELD OF THE INVENTION

The present invention relates generally to facilitating interoperability between guest operating systems and a hypervisor in hypervisor-based computer systems.

### II. BACKGROUND OF THE INVENTION

Hypervisor systems increase capability by allowing a single computer processor to appear as multiple processors through the expedient of allowing the processor to simultaneously execute multiple operating systems under the coordination of the hypervisor. In this way, each operating system in effect virtually appears as a machine that is separate from the other operating systems, although only a single processor is in fact being used.

### SUMMARY OF THE INVENTION

Because hypervisor systems have been intended to multiply a single processor into more than one virtual machine by centrally coordinating the execution by the processor of multiple operating systems, the present invention understands that limited functionality beyond VM coordination has been provided in hypervisor systems.

Accordingly, a system includes a processor executing at least one guest operating system (GOS). At least a first GOS plug-in module is associated with the GOS. The first plug-in module is executable by the processor to undertake a respective first function. A hypervisor is also executable by the processor, and the hypervisor communicates with the GOS. At least a first hypervisor plug-in module is associated with the hypervisor and is configured to communicate with the first GOS plug-in module to execute the first function.

In example embodiments at least a second GOS plug-in module is associated with the GOS and is executable by the processor to undertake a respective second function. In this case, a second hypervisor plug-in module is associated with the hypervisor and is configured to communicate with the second GOS plug-in module to execute the second function.

Multiple GOS may be provided. Accordingly, in example embodiments the GOS is a first GOS and the system further includes a second GOS. A third GOS plug-in module may be associated with the second GOS and executable by the processor to undertake the first function, with the first hypervisor plug-in module being configured to communicate with the third GOS plug-in module to execute the first function. The first and third GOS plug-in modules may communicate with each other through the hypervisor.

In some embodiments the GOS includes a service daemon interfacing the first and second GOS plug-in modules with a service daemon of the hypervisor. The first function can include logging, in the GOS, errors occurring in the hypervisor. Or, the first function can include making user credentials in the first GOS or the hypervisor available to the second GOS. Yet again, the second function may include allowing the hypervisor to set a registry key in the GOS.

In another aspect, a method includes executing a guest operating system (GOS), executing a hypervisor, and executing respective first modules associated with the GOS and hypervisor to undertake a first function. Each first module is configured to cooperate with the other first module to undertake the first function and only the first function.

In still another aspect, a computer readable storage medium bears logic executable by a processor for executing a hypervisor and first and second guest operating systems (GOS) simultaneously, and for accessing, on each GOS, multiple plug-in modules to execute respective functions.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting computer that can use the present invention; and

FIG. 2 is a block diagram of example software architecture.

### DETAILED DESCRIPTION OF THE PREFERRED EMBODIMENT

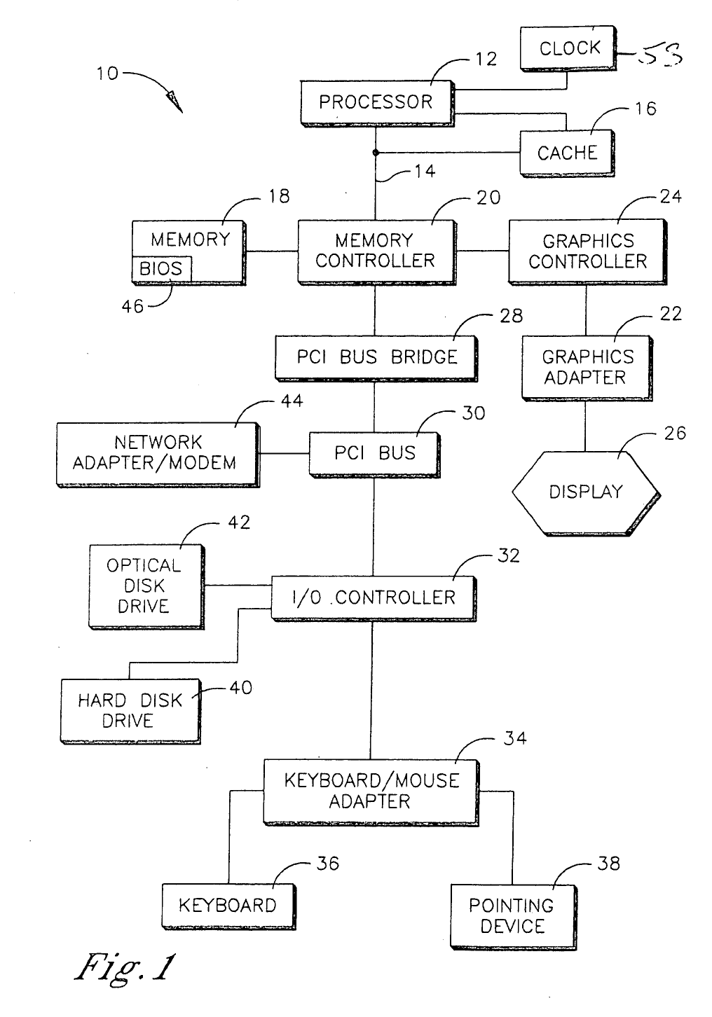

Referring initially to FIG. 1, a high-level block diagram of a data processing system, generally designated 10, is shown in which the present invention may be implemented. The system 10 in one non-limiting embodiment is a personal computer or laptop computer or server computer or other computer configured for hypervisor operation. The system 10 includes a processor 12, which may be, without limitation, a Power PC™ processor available from Lenovo (or other processors common to the industry). The processor 12 typically is connected to a processor bus 14, and a cache 16, which is used to stage data to and from the processor 12 at reduced access latency, is also typically connected to the processor bus 14.

In non-limiting embodiments the processor 12 can access data from the cache 16 or from a system solid state memory 18 by way of a memory controller function 20. The cache 16 may include volatile memory such as DRAM and the memory 18 may include non-volatile memory such as flash memory. Also, the memory controller 20 may be connected to a memory-mapped graphics adapter 22 by way of a graphic bus controller 24, and the graphics adapter 22 provides a connection for a monitor 26 on which the user interface of software executed within data processing system 10 is displayed.

The non-limiting memory controller 20 may also be connected to a personal computer interface (PCI) bus bridge 28, which provides an interface to a PCI bus 30. Connected to the PCI bus 30 may be an input/output (I/O) controller 32 for controlling various 1/0 devices, including, e.g., a keyboard/mouse adapter 34 which provides connection to a keyboard 36 and to a pointing device 38, which may be implemented by a mouse, trackball, or the like. Additionally, a hard disk drive 40 may be connected to the I/O controller 32, but in some implementations no physical HDD is implemented on the system 10 itself, and the processor 12 accesses a remote disk using iSCSI as though the remote disk were a local HDD.

As is known in the art, the HDD 40, whether local or remote, includes a controller that can access a master booth record (MBR) which can contain executable code as well as tabular data structures. If desired, an optical disk drive 42, such as a DVD or CD drive, can be connected to the 1/O controller 32. In some implementations a network adapter 44 can be attached to the PCI bus 30 as shown for connecting the data processing system 10 to a local area network (LAN), the Internet, or both. In any case, in accordance with principles known in the art, during power-on the processor 12 executes a basic input/output system (BIOS) program 46 that may be stored in the memory 18, to load an operating system in the hard disk drive 40 into the memory 18. A clock 53 may be provided for timing purposes.

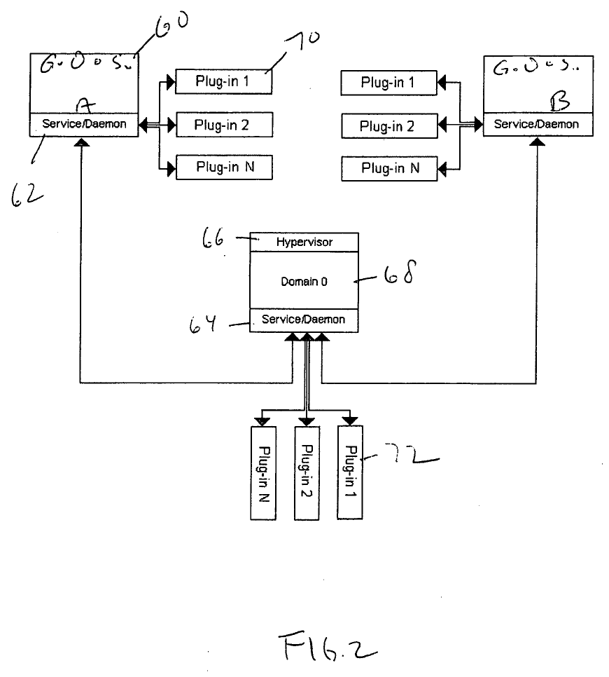

Now referring to FIG. 2, an example software architecture is shown. A Type 1 hypervisor system or a Type 2 hypervisor system may be used. The processor 12 of the system 10 can execute one or more guest operating systems (GOS) (only two GOS shown for clarity) such as but not limited to a Windows-based or Linux-based operating system.

As shown, each GOS 60 includes a respective service daemon 62 that is a communication interface with a service daemon 64 of a hypervisor 66. The hypervisor 66 may include an interface domain 68 colloquially referred to as “D0”. By means of the service daemons 62, 64, the GOS 60 can communicate with each other and with the domain D0.

To attend to type of data and format be communicated to execute particular functions, for each function sought to be executed the GOS 60 are provided with respective GOS plug-in modules 70, with each GOS plug-in module 70 configured for a single task and with a respective hypervisor plug-in module 72 being provided for the hypervisor 66 for each GOS plug-in module 70. A hypervisor plug-in module 72 is configured to communicate with its associated GOS plug-in module 70 to execute a task or function, so that individual functionalities may thus be added by adding plug-in modules to the system. As shown, the GOS plug-in modules 70 communicate with the service daemon 62 of the respective GOS while the hypervisor plug-in modules 72 communicate with the hypervisor service daemon 64.

Among the functions provided by the plug-in modules may be rebooting the GOS in which the plug-in resides, storing user credentials, posting information to the event viewer, etc. As an example, single sign-on functionality may be provided in which one GOS 60 requires user credentials that are stored on another GOS 60, meaning that the credentials required by one GOS can be queried for through the appropriate GOS plug-in modules 70 associated with the single sign-on functionality from another GOS.

In another example, errors may be logged from one domain to another domain, e.g., from the domain D0 in the hypervisor 66 to one of the GOS 60. In this case, a hypervisor plug-in module 72 and a complementary GOS plug-in module 70 are provided with instructions as to how to log errors to the GOS event viewer. Consequently, the hypervisor domain 0 may send data to the GOS plug-in module in the target GOS to post information to the event viewer of the GOS.

Another function for which respective plug-in modules 70, 72 may be provided include allowing the hypervisor to set a registry key in a GOS.

While the particular PLUG-IN ARCHITECTURE FOR HYPERVISOR-BASED SYSTEM is herein shown and described in detail, it is to be understood that the subject matter which is encompassed by the present invention is limited only by the claims.

What is claimed is:

1. A system comprising:
a processor executing at least one guest operating system (GOS);
at least a first GOS plug-in module associated with the GOS, the first plug-in module being executable by the processor to undertake a respective first function;
a hypervisor executable by the processor and communicating with the GOS; and
at least a first hypervisor plug-in module associated with the hypervisor and being configured to communicate with the first GOS plug-in module to execute the first function.

2. The system of claim 1, comprising:
at least a second GOS plug-in module associated with the GOS, the second plug-in module being executable by the processor to undertake a respective second function; and
at least a second hypervisor plug-in module associated with the hypervisor and being configured to communicate with the second GOS plug-in module to execute the second function.

3. The system of claim 1, wherein the GOS is a first GOS and the system comprises:
a second GOS;
at least a third GOS plug-in module associated with the second GOS, the third plug-in module being executable by the processor to undertake the first function, the first hypervisor plug-in module being configured to communicate with the third GOS plug-in module to execute the first function.

4. The system of claim 3, wherein the first and third GOS plug-in modules communicate with each other through the hypervisor.

5. The system of claim 2, wherein the GOS includes a service daemon interfacing the first and second GOS plug-in modules with a service daemon of the hypervisor.

6. The system of claim 1, wherein the first function includes logging, in the GOS, errors occurring in the hypervisor.

7. The system of claim 3, wherein the first function is making user credentials in the first GOS or the hypervisor available to the second GOS.

8. The system of claim 2, wherein the second function is allowing the hypervisor to set a registry key in the GOS.

9. A method comprising:
executing a guest operating system (GOS);
executing a hypervisor; and
executing respective first modules associated with the GOS and hypervisor to undertake a first function, each first module being configured to cooperate with the other first module to undertake the first function and only the first function.

10. The method of claim 9, wherein the first modules are first plug-in modules.

11. The method of claim 10, comprising:
executing a second GOS plug-in module associated with the GOS to undertake a second function; and
executing a second hypervisor plug-in module associated with the hypervisor to execute the second function.

12. The method of claim 10, wherein the GOS is a first GOS and the method comprises:
executing a second GOS simultaneously with executing the first GOS under coordination provided by the hypervisor;
executing at least a third GOS plug-in module associated with the second GOS to undertake the first function.

13. The method of claim 12, wherein the first and third GOS plug-in modules communicate with each other through the hypervisor.

14. The method of claim 11, wherein the GOS includes a service daemon interfacing the first and second GOS plug-in modules with a service daemon of the hypervisor.

15. The method of claim 9, wherein the first function includes logging, in the GOS, errors occurring in the hypervisor.

16. The method of claim 12, wherein the first function is making user credentials in the first GOS or the hypervisor available to the second GOS.

17. The method of claim 11, wherein the second function is allowing the hypervisor to set a registry key in the GOS.

18. A computer readable storage medium comprising logic executable by a processor for:
executing a hypervisor and first and second guest operating systems (GOS) simultaneously; and
accessing on each GOS multiple plug-in modules to execute respective functions.

19. The medium of claim 18, wherein a first function includes logging, in a GOS, errors occurring in the hypervisor.

20. The medium of claim 18, wherein a first function is making user credentials in a first GOS or the hypervisor available to a second GOS.

21. The medium of claim 18, wherein a second function is allowing the hypervisor to set a registry key in a GOS.
